(19) United States
(12) Patent Application Publication
(10) Pub. No.: US 2003/0183178 A1
(43) Pub. Date: Oct. 2, 2003

(54) Process for operating diesel engines

(76) Inventors: Rinaldo Caprotti, Oxfordshire (GB); Peter Van Leest, Rotterdam (NL)

Correspondence Address: Infineum USA, Law Department, 1900 East Linden Avenue, P O Box 710, Linden, NJ, 07036-0710, US

(21) Appl. No.: 10/258,419

(22) PCT Filed: May 14, 2001
(86) PCT No.: PCT/EP01/05486

(30) Foreign Application Priority Data
May 16, 2000 (GB) 00119081

(51) Int. Cl. F02B 3/00

(52) U.S. Cl. 123/1 A; 123/27 R

(57) ABSTRACT

The operation of marine diesel engines is improved through use of a defined fuel composition, containing one or more additives comprising a methal detergent, a non-metal detergent or both. The fuel is supplied to Diesel engines which operate in a maximum speed range of 1000 rpm (4-stroke engine) respectively 2500 rpm (2-stroke engine). The power output is greater than 200 bph. The cylinder bore is greater than 100 mm (2-stroke engine) while the piston stroke shall be greater than 150 mm (4-stroke engine) respectively greater than 120 mm (2-stroke engine). The metal containing detergent is a neutral calcium sulfonate, salicylate or calcium phenate. The non-metal containing detergent is a hydrocarbyl succinimide.

This invention concerns the improved operation of larger diesel engines such as engines for stationary applications (e.g. power plants), railway or especially marine diesel engines, through use of a fuel composition having particular advantages.

Larger diesel engines, such as marine engines, may be of four-stroke or two-stroke design and may be characterised by one or more of the following operating parameters:

(i) a maximum engine speed of no more than 1000 rpm (revolutions per minute) for four stroke engines, and of no more than 2,500 rpm for two stroke engines;

(ii) a power output of greater than 200 bhp (brake horse-power);

(iii) a cylinder bore dimension of greater than 150 mm for four stroke engines, (such as greater than 200 mm) or of greater than 100 mm for two stroke engines; and

(iv) a piston stroke of greater than 150 mm for four stroke engines (such as greater than 250 mm) or of greater than 120 mm for two-stroke engines.

Such engines are typically used in commercial marine propulsion applications such as fishing vessels. These engines are required to run for extended periods and may be subjected to sub-optimal conditions during use, such as water contamination of the fuel and sudden changes in load. Service intervals may also be infrequent or irregular.

Typically, such engines have suffered from the problem of in-cylinder deposits, such as varnish and lacquer deposits on pistons or cylinder liners, which can produce undesirable consequences such as sub-optimal combustion and types of in-cylinder wear known as bore polishing (where the cylinder liner is rubbed to a smooth ‘polish’) and scuffing (where scratching of the liner surface is observed).

In addition, with continued use the oil consumption of such engines tends to increase, partly as a consequence of the in-cylinder wear and the formation of varnish and laquer on the cylinder liners, and partly due to changes in the viscosity of the lubricating oil during use. Increased combustion of the lubricant can also increase the levels of in-cylinder deposits, so perpetuating the deposit and potentially the wear problems, as well as generating higher smoke emissions and reducing effective life of the engine.

The development of such problems also appears influenced by the fuel composition. Diesel fuels and fuel oils from different sources may exhibit wide variations in properties and quality, due partly to the tendency of fuel manufacturers to preferentially use higher-grade blending streams in higher-value products such as automotive diesel fuels. As a result, marine diesel fuels may comprise the remaining, lower-grade streams making up the middle distillate blending pool, such as streams produced from (i) fluid catalytic cracking, such materials usually having a density @15° C. of 850 to 970, such as 900 to 970 kg/m³, and characterised by low cetane number values, typically ranging from 10 or lower to around 30 to 35; (ii) thermal cracking processes, like visbreaking and coking, such streams typically having a density range @15° C. of 830 to 930 kg/m³ and a cetane value of 20 to 50; or (iii) hydrocracking that uses severe conditions, e.g. temperature in excess of 400° C. coupled with pressures of 130 bars or greater, to produce streams characterised by cetane number from 45 to 60 and having a density range @15° C. from 800 to 860 kg/m³ In particular, sulfur and aromatic levels may be higher in such fuels than in automotive diesel or domestic heating oils. Such components may contribute to the above-mentioned problems, as well as generally poorer combustion.

The design characteristics of marine engines (and related engines, such as power plant and railway engines) are also thought to contribute to the above described problems. Due to engine design and cylinder dimensions, the combustion chambers of such marine engines tend to have smaller surface area: volume ratios than, for example, automotive diesel engines, resulting in higher surface concentrations of in-cylinder deposits resulting from combustion. A large volume of relatively low-grade fuel is injected during each stroke at relatively high pressure, to ensure adequate penetration of the large air charge within each cylinder, which increases the likelihood of entrainment on the cylinder walls and subsequent deposit formation. Engines having the operating parameters defined above thus appear especially prone to the in-cylinder conditions which result in the above-described problems, and accordingly suffer field problems.

The present invention is concerned with alleviating these problems through use of a particular fuel composition.

In a first aspect therefore, the invention provides a process for operating a diesel engine comprising:

a) the preparation of a diesel fuel or fuel oil composition by admixture of a diesel fuel or fuel oil and one or more additives comprising a metal containing detergent, non-metal containing detergent or both; and

b) supplying the fuel composition to an engine having one or more of the following operating parameters:

(i) a maximum engine speed of no more than 1000 rpm (revolutions per minute) for four stroke engines, and of no more than 2,500 rpm for two stroke engines;

(ii) a power output of greater than 200 bhp (brake horse-power);

(iii) a cylinder bore dimension of greater than 150 mm for four stroke engines (such as greater than 200 mm) or of greater than 100 mm for two stroke engines; and

(iv) a piston stroke of greater than 150 mm for four stroke engines (such as greater than 250 mm) or of greater than 120 mm for two-stroke engines.

In tests, the addition of the above additive(s) to engine lubricating oil has been found to increase the viscosity of the lubricating oil. This effect can occur rapidly; in contrast, the onset of increased oil consumption during engine operation is gradual. The effect of the additive(s) upon entrainment in the oil can therefore counter the oil consumption increase by increasing the oil's ability to adhere to in-cylinder surfaces. Furthermore, the varnish and lacquer deposits observed within the cylinders of the engine may be controlled, in the senses that deposits are both prevented and removed from combustion-chamber and related surfaces, following introduction of the defined fuel composition, through its entrainment in the lubricating oil and subsequent local action, for example to inhibit polishing or scuffing. In addition, the entrainment of the additive in the oil allows the enhancement of properties of the lubricant, for example, controlling the consequences of lubricant contamination, such as black sludge, piston crown deposits and fuel pump plunger sticking.

In a second aspect therefore, the invention provides the use of the diesel fuel or fuel oil composition defined in the first aspect, in a diesel engine having the operating parameters defined in the first aspect, to improve the viscometric properties of the lubricating oil, and so to improve the oil consumption of the engine or reduce the in-cylinder deposits of the engine, or both.

The invention will now be described in more detail as follows:

The fuel composition is prepared by admixture of the fuel and one or more metal-containing detergents or non metal-containing detergents or both. Preferably, both types of detergent are present.

Diesel Fuel or Fuel Oil

Suitable fuels generally boil within the range of about 100° C. to about 500° C., e.g. 150° to about 450° C., for example, those having a relatively high Final Boiling Point of above 360° C. (ASTM D-86). Such distillates contain a spread of hydrocarbons boiling over a temperature range, including n-alkanes which precipitate as wax as the fuel cools. They may be characterised by the temperatures at which various %'s of fuel have vaporised, e.g. 10% to 90%, being the interim temperatures at which a certain volume % of initial fuel has distilled.

The difference between say 90% and 20% distillation temperature may be significant. They are also characterised by pour, cloud and CFPP points, as well as their initial boiling point (IBP) and final boiling point (FBP), cetane number, viscosity and density. The petroleum fuel oil can comprise atmospheric distillate or vacuum distillate, or cracked gas oil or a blend in any proportion of straight run and thermally and/or catalytically cracked distillates.

The fuel may in particular have one or more of the following characteristics:

(i) a 95% distillation point (ASTM D86) of greater than 330° C., preferably greater than 360° C., more preferably greater than 400° C., and most preferably greater than 430° C.;

(ii) a cetane number (measured by ASTM D613) of less than 55, such as less than 53, preferably less than 49, more preferably less than 45, most preferably less than 40,

(iii) an aromatic content of greater than 15% wt, preferably greater than 25% and more preferably greater than 40%; and

(iv) a Ramsbottom carbon residue (by ASTM D 524) of greater than 0.01% mass, preferably greater than 0.15% mass, more preferably greater than 0.3% mass, such as 1% or 5% mass, and most preferably greater than 10% mass.

As described earlier, these fuels may in particular contain streams such as streams produced from fluid catalytic cracking, such materials usually having a density @15° C. of 850 to 970, such as 900 to 970 kg/m³ and characterised by low cetane number values, typically ranging from 10 or lower to around 30 to 35; from thermal cracking processes, like visbreaking and coking, such streams typically having a density range @15° C. of 830 to 930 kg/m³ and a cetane value of 20 to 50; and from hydrocracking that uses severe conditions, e.g. temperature in excess of 400° C. coupled with pressures of 130 bars or greater, to produce streams characterised by cetane number from 45 to 60 and having a density range @15° C. from 800 to 860 kg/m³.

Typically, marine fuels accord with the standard specification ASTM D-2069 and may be either distillate or residual fuels as described within that specification, and may in particular have sulfur contents of greater than 0.05%, preferably greater than 0.1%, more preferably greater than 0.2% and particularly greater than 1% or even 2% by weight, especially in the case of residual fuel oils, and a kinematic viscosity at 40° C. in cSt of at least 1.40.

The fuel oil may also be an animal or vegetable oil, or a mineral oil as described above in combination with an animal or vegetable oil. Fuels from animal or vegetable sources are known as biofuels and are obtained from a renewable source. Certain derivatives of vegetable oil, for example rapeseed oil, e.g. those obtained by saponification and re-esterification with a monohydric alcohol, may be used. It has recently been reported that mixtures of a rapeseed ester, for example, rapeseed methyl ester (RME), with petroleum distillate fuels in ratios of, for example, 10:90 or 5:95 by volume are likely to be commercially available.

Thus, a biofuel is a vegetable or animal oil or both or a derivative thereof, particularly an oil comprising fatty acid and/or fatty acid esters.

Vegetable oils are mainly triglycerides of monocarboxylic acids, e.g. acids containing 10-25 carbon atoms and listed below:

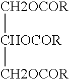

where R is an aliphatic radical of 10-25 carbon atoms which may be saturated or unsaturated.

Generally, such oils contain glycerides of a number of acids, the number and kind varying with the source vegetable of the oil.

Examples of oils are rapeseed oil, coriander oil, soyabean oil, cottonseed oil, sunflower oil, castor oil, olive oil, peanut oil, maize oil, almond oil, palm kernel oil, coconut oil, mustard seed oil, beef tallow and fish oils. Rapeseed oil, sunflower oil, soya bean oil and palm oil, is preferred as it is available in large quantities and can be obtained in a simple way by pressing from rapeseed.

Examples of derivatives thereof are alkyl esters, such as methyl esters, of fatty acids of the vegetable or animal oils. Such esters can be made by transesterification.

As lower alkyl esters of fatty acids, consideration may be given to the following, for example as commercial mixtures: the ethyl, propyl, butyl and especially methyl esters of fatty acids with 12 to 22 carbon atoms, for example of lauric acid, rosin acid (e.g. abietic acid and related structures such as dehydroabietic acid) myristic acid, palmitic acid, palmitoleic acid, stearic acid, oleic acid, elaidic acid, petroselic acid, ricinoleic acid, elaeostearic acid, linoleic acid, linolenic acid, eicosanoic acid, gadoleic acid, docosanoic acid or erucic acid, which have an iodine number from 50 to 180, especially 90 to 125. Mixtures with particularly advantageous properties are those which contain mainly, i.e. to at least 50 mass % methyl esters of fatty acids with 16 to 22 carbon atoms and 1, 2 or 3 double bonds. The preferred lower alkyl esters of fatty acids are the methyl esters of oleic acid, linoleic acid, linolenic acid and erucic acid, and mixtures thereof.

Commercial mixtures of the stated kind are obtained for example by cleavage and esterification of natural fats and oils by their transesterification with lower aliphatic alcohols. For production of lower alkyl esters of fatty acids it is advantageous to start from fats and oils with high iodine number, such as, for example, sunflower oil, rapeseed oil, coriander oil, castor oil, soyabean oil, cottonseed oil, peanut oil, fall oil or beef tallow. Lower alkyl esters of fatty acids based on a new variety of rapeseed oil, the fatty acid component of which is derived to more than 80 mass % from unsaturated fatty acids with 18 carbon atoms, are preferred.

Preferably the biofuel is present in an amount of up to 50 mass % based on the mass of the middle distillate fuel oil, more preferably of up to 10 mass %, especially up to 5 mass %.

The fuel may alternatively be a fuel oil (either distillate or residual fuel) such as a heating fuel oil or powerplant fuel.

Metal-Containing Detergent

The metal-containing detergent may, for example, be an alkaline earth metal or alkali metal compound, or a plurality of such compounds.

In both aspects of the invention, whilst overbased compounds may be used, a neutral alkaline earth metal is particularly suitable, especially one selected from the group consisting of calcium and magnesium, although barium and strontium may also be used. Preferably the alkaline earth metal compound is a calcium compound.

In both aspects of the invention, a neutral alkali metal is also suitable in the present invention and is preferably selected from the group consisting of lithium, sodium and potassium. Preferably the alkali metal compound is a sodium or potassium compound, more preferably a sodium compound.

Preferably the neutral alkaline earth metal and neutral alkali metal compounds are salts of organic acids. As examples of organic acids, there may be mentioned carboxylic acids and anhydrides thereof, phenols, sulfurised phenols, salicylic acids and anhydrides thereof, alcohols, dihydrocarbyldithiocarbamic acids, dihydrocarbyldithiophosphoric acids, dihydrocarbylphosphonic acids, dihydrocarbylthiophosphonic acids and sulfonic acids.

The term ‘neutral’ as used herein refers to metal compounds, preferably metal salts of organic acids, that are stoichiometric or predominantly neutral in character, that is most of the metal is associated with an organic anion. For a metal compound to be completely neutral, the total number of moles of the metal cation to the total number of moles of organic anion associated with the metal will be stoichiometric. For example, for every one mole of calcium cations there should be two moles of sulfonate anions.

The metal salts of the present invention include predominantly neutral salts where minor amounts of non-organic anions, for example carbonate and/or hydroxide anions, may also be present provided their presence does not alter the predominantly neutral character of the metal salt.

Thus, metal salts of the present invention preferably have a metal ratio of less than 2, more preferably less than 1.95, especially less than 1.9, advantageously less than 1.8, more especially less than 1.6, for example less than 1.5, such as less than 1.4 or less than 1.35. The metal ratio is preferably at least about 1.0. The metal ratio, as used herein, is the ratio of total metal to the metal associated with the organic anion. So metal salts having a metal ratio of less than 2 have greater than 50% of the metal associated with the organic anion.

The metal ratio can be calculated by

a) measuring the total amount of metal in the neutral metal salt; and then

b) determining the amount of metal associated with the organic.

Suitable methods for measuring the total metal content are well known in the art and include X-ray fluorescence and atomic absorption spectrometry.

Suitable methods for determining the amount of metal associated with the organic acid include potentiometric acid titration of the metal salt to determine the relative proportions of the different basic constituents (for example, metal carbonate and metal salt of organic acid); hydrolysis of a known amount of metal salt and then the potentiometric base titration of the organic acid to determine the equivalent moles of organic acid; and determination of the non-organic anions, such as carbonate, by measuring the CO₂ content.

In the case of a metal sulfonate, ASTM D3712 may be used to determine the metal associated with the sulfonate.

In the instance where a composition comprises one or more neutral metal salts and one or more co-additives, then the neutral metal salt(s) may be separated from the co-additives, for example, by using dialysis techniques and then the neutral metal salt may be analysed as described above to determine the metal ratio. Background information on suitable dialysis techniques is given by Amos, R. and Albaugh, E. W. in “Chromatography in Petroleum Analysis” Altgelt, K. H. and Gouw, T. H., Eds., pages 417 to 421, Marcel Dekker Inc., New York and Basel, 1979.

Specific examples of organic acids include hydrocarbyl sulfonic acids, hydrocarbyl substituted phenols, hydrocarbyl substituted sulfurised phenols, hydrocarbyl substituted salicylic acids, dihydrocarbyldithiocarbamic acid, dihydrocarbyldithiophosphoric acid, and aliphatic and aromatic carboxylic acids.

The neutral metal salts of the present invention may be salts of one chemical type or salts of more than one chemical type. Preferably, they are salts of one type.

Sulfonic acids used in accordance with this aspect of the invention are typically obtained by sulfonation of hydrocarbyl-substituted, especially alkyl-substituted, aromatic hydrocarbons, for example, those obtained from the fractionation of petroleum by distillation and/or extraction, or by the alkylation of aromatic hydrocarbons. Examples include those obtained by alkylating benzene, toluene, xylene, naphthalene, biphenyl or their halogen derivatives, for example, chlorobenzene, chlorotoluene or chloronaphthalene. Alkylation of aromatic hydrocarbons may be carried out in the presence of a catalyst with alkylating agents having from about 3 to more than 100 carbon atoms, such as, for example, haloparaffins, olefins that may be obtained by dehydrogenation of paraffins, and polyolefins, for example, polymers of ethylene, propylene, and/or butene. The alkylaryl sulfonic acids usually contain from about 22 to about 100 or more carbon atoms; preferably the alkylaryl sulfonic acids contain at least 26 carbon atoms, especially at least 28, such as at least 30, carbon atoms. The sulfonic acids may be substituted by more than one alkyl group on the aromatic moiety, for example they may be dialkylaryl sulfonic acids. The alkyl group preferably contains from about 16 to about 80 carbon atoms, with an average number of carbon atoms in the range of from 36-40, or an average carbon number of 24, depending on the source from which the alkyl group is obtained. Preferably the sulfonic acid has a number average molecular weight of 350 or greater, more preferably 400 or greater, especially 500 or greater, such as 600 or greater. Number average molecular weight may be determined by ASTM D3712.

When neutralising these alkylaryl sulfonic acids to provide sulfonates, hydrocarbon solvents and/or diluent oils may also be included in the reaction mixture, as well as promoters.

Another type of sulfonic acid which may be used in accordance with the invention comprises alkyl phenol sulfonic acids. Such sulfonic acids can be sulfurized. Preferred substituents in alkyl phenol sulfonic acids are substituents represented by R in the discussion of phenols below.

Sulfonic acids suitable for use in accordance with the invention also include alkyl sulfonic acids. In such compounds the sulfonic acid suitably contains 22 to 100 carbon atoms, advantageously 25 to 80 carbon atoms, especially 30 to 60 carbon atoms.

Preferably the sulfonic acid is hydrocarbyl-substituted aromatic sulfonic acid, more preferably alkyl aryl sulfonic acid.

Phenols used in accordance with the invention may be non-sulfurized or, preferably, sulfurized. Further, the term “phenol” as used herein includes phenols containing more than one hydroxyl group (for example, alkyl catechols) or fused aromatic rings (for example, alkyl naphthols) and phenols which have been modified by chemical reaction, for example, alkylene-bridged phenols and Mannich base-condensed phenols; and saligenin-type phenols (produced by the reaction of a phenol and an aldehyde under basic conditions).

Preferred phenols from which neutral calcium and/or magnesium salts in accordance with the invention may be derived are of the formula

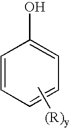

where R represents a hydrocarbyl group and y represents 1 to 4. Where y is greater than 1, the hydrocarbyl groups may be the same or different.

The phenols may also be calixarenes, especially of the formula:

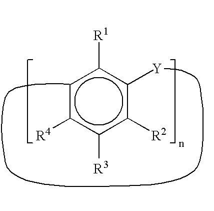

Wherein:

Y is a divalent bridging group;

R³ is hydrogen, a hydrocarbyl or a hetero-substituted hydrocarbyl group;

either R¹ is hydroxyl and R² and R⁴ are independently either hydrogen, hydrocarbyl or hetero-substituted hydrocarbyl, or R² and R⁴ are hydroxyl and R¹ is either hydrogen, hydrocarbyl or hetero-substituted hydrocarbyl; and

n has a value of at least 4.

The phenols are frequently used in sulfurized form. Sulfurized hydrocarbyl phenols may typically be represented by the formula:

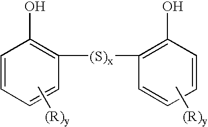

where x, represents an integer from 1 to 4. In some cases, more than two phenol molecules may be linked by (S)ₓ bridges, where S represents a sulfur atom.

In the above formulae, hydrocarbyl groups represented by R are advantageously alkyl groups, which advantageously contain 5 to 100 carbon atoms, preferably 5 to 40 carbon atoms, especially 9 to 12 carbon atoms, the average number of carbon atoms in all of the R groups being at least about 9 in order to ensure adequate solubility or dispersibility in oil. Preferred alkyl groups are nonyl (e.g. tripropylene) groups or dodecyl (e.g. tetrapropylene) groups.

In the following discussion, hydrocarbyl-substituted phenols will for convenience be referred to as alkyl phenols.

A sulfurizing agent for use in preparing a sulfurized phenol or phenate may be any compound or element which introduces —(S)ₓ— bridging groups between the alkyl phenol monomer groups, wherein x is generally from 1 to about 4. Thus, the reaction may be conducted with elemental sulfur or a halide thereof, for example, sulfur dichloride or, more preferably, sulfur monochloride. If elemental sulfur is used, the sulfurisation reaction may be effected by heating the alkyl phenol compound at from 50 to 250° C., and preferably at least 100° C. The use of elemental sulfur will typically yield a mixture of bridging groups —(S)ₓ— as described above. If a sulfur halide is used, the sulfurisation reaction may be effected by treating the alkyl phenol at from −10° C. to 120° C., preferably at least 60° C. The reaction may be conducted in the presence of a suitable diluent. The diluent advantageously comprises a substantially inert organic diluent, for example mineral oil or an alkane. In any event, the reaction is conducted for a period of time sufficient to effect substantial reaction. It is generally preferred to employ from 0.1 to 5 moles of the alkyl phenol material per equivalent of sulfurizing agent.

Where elemental sulfur is used as the sulfurizing agent, it may be desirable to use a basic catalyst, for example, sodium hydroxide or an organic amine, preferably a heterocyclic amine (e.g., morpholine).

Details of sulfurisation processes are well known to those skilled in the art, for example U.S. Pat. No. 4,228,022 and U.S. Pat. No. 4,309,293.

As indicated above, the term “phenol” as used herein includes phenols which have been modified by chemical reaction with, for example, an aldehyde, and Mannich base-condensed phenols.

Aldehydes with which phenols used in accordance with the invention may be modified include, for example, formaldehyde, propionaldehyde and butyraldehyde. The preferred aldehyde is formaldehyde. Aldehyde-modified phenols suitable for use in accordance with the present invention are described in, for example, U.S. Pat. No. 5,259,967.

Mannich base-condensed phenols are prepared by the reaction of a phenol, an aldehyde and an amine. Examples of suitable Mannich base-condensed phenols are described in GB-A-2 121 432.

In general, the phenols may include substituents other than those mentioned above. Examples of such substituents are methoxy groups and halogen atoms.

Salicylic acids used in accordance with the invention may be non-sulfurized or sulfurized, and may be chemically modified and/or contain additional substituents, for example, as discussed above for phenols. Processes similar to those for phenols may also be used for sulfurizing a hydrocarbyl-substituted salicylic acid, and are well known to those skilled in the art. Salicylic acids are typically prepared by the carboxylation, by the Kolbe-Schmitt process, of phenoxides, and in that case, will generally be obtained (normally in a diluent) in admixture with uncarboxylated phenol.

Preferred substituents in oil-soluble salicylic acids from which neutral calcium and/or magnesium salts in accordance with the invention may be derived are the substituents represented by R in the above discussion of phenols. In alkyl-substituted salicylic acids, the alkyl groups advantageously contain 5 to 100 carbon atoms, preferably 9 to 30 carbon atoms, especially 14 to 20 carbon atoms.

Alcohols which may be used are mono- and polyols. The alcohols preferably have sufficient number of carbon atoms to provide adequate oil solubility or dispersibility to a metal salt thereof. Preferred alcohols have at least 4 carbon atoms, an example of which is tertiary butyl alcohol.

Carboxylic acids which may be used in accordance with the invention include mono- and dicarboxylic acids. Preferred monocarboxylic acids are those containing 6 to 30 carbon atoms, especially 8 to 24 carbon atoms. (Where this specification indicates the number of carbon atoms in a carboxylic acid, the carbon atom(s) in the carboxylic group(s) is/are included in that number.) Examples of monocarboxylic acids are iso-octanoic acid, stearic acid, oleic acid, palmitic acid and behenic acid. Iso-octanoic acid may, if desired, be used in the form of the mixture of C8 acid isomers sold by Exxon Chemical under the trade name “Cekanoic”. Other suitable acids are those with tertiary substitution at the α-carbon atom and dicarboxylic acids with 2 or more carbon atoms separating the carboxylic groups. Further, dicarboxylic acids with more than 35 carbon atoms, for example, 36 to 100 carbon atoms, are also suitable. Unsaturated carboxylic acids can be sulfurized.

Specific examples of carboxylic acids include alkyl and alkenyl succinic acids and anhydrides thereof. Also applicable are aromatic carboxylic acids and naphthenic acids and hydrocarbyl derivatives thereof. Neo acids such as neodecanoic acid and polycarboxylic acids may advantageously be employed.

The organic acids described in GB-A-2,248,068 are herein incorporated by reference.

In the instance where more than one type of organic acid is present in the metal salt, the proportion of any one type to another is not critical provided the neutral character of the metal is not altered.

It will be appreciated by one skilled in the art that a single type of organic acid may contain a mixture of acids of the same chemical type. For example, a sulfonic acid surfactant may contain a mixture of sulfonic acids of varying molecular weights.

As used in this specification the term “hydrocarbyl” refers to a group having a carbon atom directly attached to the rest of the molecule and having a hydrocarbon or predominantly hydrocarbon character. Examples include hydrocarbon groups, including aliphatic (e.g. alkyl or alkenyl), alicyclic (e.g. cycloalkyl or cycloalkenyl), aromatic, and alicyclic-substituted aromatic, and aromatic-substituted aliphatic and alicyclic groups. Aliphatic groups are advantageously saturated. These groups may contain non-hydrocarbon substituents provided their presence does not alter the predominantly hydrocarbon character of the group. Examples include keto, halo, hydroxy, nitro, cyano, alkoxy and acyl. If the hydrocarbyl group is substituted, a single (mono) substituent is preferred.

Examples of substituted hydrocarbyl groups include 2-hydroxyethyl, 3-hydroxypropyl, 4-hydroxybutyl, 2-ketopropyl, ethoxyethyl, and propoxypropyl. The groups may also or alternatively contain atoms other than carbon in a chain or ring otherwise composed of carbon atoms. Suitable hetero atoms include, for example, nitrogen, sulfur, and, preferably, oxygen.

In all aspect of the invention, the Total Base Number (TBN), as measured according to ASTM D2896, of the neutral alkaline earth metal compounds and neutral alkali metal compounds is at most 150, such as at most 100, preferably at most 80, more preferably at most 70, advantageously at most 60, such as less than 50.

In both aspects of the invention, a preferred neutral alkaline earth metal compound is calcium sulfonate or calcium salicylate; especially preferred is a calcium salicylate.

In both aspects of the invention, a preferred neutral alkali metal compound is selected from the group consisting of sodium sulfonate, sodium salicylate, potassium sulfonate and potassium salicylate.

In both aspects of the invention, the metal containing detergent may advantageously be a calcium phenate.

Alternatively, or additionally, the metal-containing detergent may comprise one or more transition metal compounds.

In both aspects of the invention, the transition metal is preferably selected from the group consisting of iron, manganese, copper, molybdenum, cerium, chromium, cobalt, nickel, zinc, vanadium and titanium; more preferably, the transition metal is iron.

The compound of the transition metal is preferably selected from an organic acid salt of a transition metal; ferrocene (Fe[C₅H₅]₂) or a derivative thereof; and a manganese carbonyl compound or a derivative thereof.

The organic acids suitable for the transition metal are the same as those described above for the neutral alkaline earth metal and alkali metals. Specific examples of preferred transition metal compounds of organic acids are iron naphthenate, iron oleate, copper naphthenate, copper oleate, copper dithiocarbamate, copper dithiophosphate, zinc dithiophosphate, zinc dithiocarbamate, molybdenum dithiocarbamate, molybdenum dithiophosphate, cobalt naphthenate, cobalt oleate, nickel oleate, nickel naphthenate, manganese naphthenate and manganese oleate. Also suitable are alkenyl and alkyl succinate salts of iron, copper, cobalt nickel and manganese.

Other examples of transition metal compounds are π-bonded ring compounds where the number of carbon atoms in the ring may be in the range of from 2 to 8, such as [C₅H₅], [C₆H₆], [C₈H₈]. Examples are dibenzenechromium and dicyclopentadienyl manganese. Transition metal compounds with one π-bonded ring and other ligands such as halogens, CO, RNC and R₃P (where R is a hydrocarbyl group and may be the same or different when there is more than one R group) are also within the scope of the invention. The π-bonded ring may be heterocyclic such as [C₄H₄N], [C₄H₄P] and [C₄H₄S].

Examples of iron compounds include iron (II) and iron (III) compounds, and derivatives of ferrocene such as bis(alkyl substituted cyclopentadienyl) iron compounds, for example bis(methyl cyclopentadienyl) iron. Also compounds such as cyclopentadienyl iron carbonyl compounds, for example, [C₅H₆]Fe(CO)₃ and [C₅H₅]Fe(CO)₂Cl; [C₅H₅][C₄H₄N]Fe; and [C₅H₅][C₄H₄P]Fe are suitable in the present invention.

Examples of manganese compounds and derivatives thereof include those described in EP-A-0,476,196 which are incorporated herein by reference. Specific examples are cyclopentadienyl manganese carbonyl compounds such as cyclopentadienyl manganese tricarbonyl and methyl cyclopentadienyl manganese tricarbonyl.

In all aspects of the invention, the fuel-soluble or fuel-dispersible transition metal compound is preferably ferrocene or an iron salt of an organic acid, or an overbased salt thereof, such as iron napthenate or salicylate.

As an alternative to, or in addition to, one or more metal salts of an inorganic acid, the metal compounds may be in the form of a colloidal dispersion of an inorganic salt, e.g. an oxide or carbonate, i.e. may be overbased.

In the instance where two or more metal compounds are present in the additive composition from any one of the categories of metal compounds, that is (i) neutral alkaline earth metal compounds, (ii) neutral alkali metal compounds and (iii) transition metal compounds, the compounds may be of the same or of different metals within the category.

Concentration and Proportion

In both aspects of the invention, the total amount of metal by mass, derived from the or each neutral alkaline earth metal compound and/or neutral alkali metal compound and/or transition metal compound, in the fuel oil composition is at most 1000 ppm, but normally at most 250 ppm; preferably the total amount of metal is at most 200 ppm, more preferably at most 150 ppm; advantageously at most 100 ppm; especially at most 50 ppm, such as at most 25 ppm, for example in the range of from 0.1 to 10 ppm or 0.5 to 5 ppm.

The amount of alkaline earth metal in the fuel oil composition is measured by atomic absorption; the amount of alkali metal in the fuel oil composition is measured by atomic absorption; and the amount of transition metal in the fuel oil composition is measured by atomic absorption.

The Non Metal-Containing Detergent

The detergent may be a hydrocarbylamine, such as a polyisobutylene polyamine. The preferred detergent is an ashless dispersant comprising an acylated nitrogen compound, preferably having a hydrocarbyl substitutent of at least 10 aliphatic carbon atoms, made by reacting a carboxylic acid acylating agent with at least one amine compound containing at least one —NH-group, said acylating agent being linked to said amino compound through an imido, amido, amidine or acyloxy ammonium linkage.

A number of acylated, nitrogen-containing compounds having a hydrocarbyl substituent of at least 10 carbon atoms and made by reacting a carboxylic acid acylating agent, for example an anhydride or ester, with an amino compound are known to those skilled in the art. In such compositions the acylating agent is linked to the amino compound through an imido, amido, amidine or acyloxy ammonium linkage. The hydrocarbyl substituent of 10 carbon atoms may be found either in the portion of the molecule derived from the carboxylic acid acylating agent, or in the portion derived from the amino compound, or in both. Preferably, however, it is found in the acylating agent portion. The acylating agent can vary from formic acid and its acylating derivatives to acylating agents having high molecular weight hydrocarbyl substituents of up to 5000, 10000 or 20000 carbon atoms. The amino compounds can vary from ammonia itself to amines having hydrocarbyl substituents of up to about 30 carbon atoms.

A preferred class of acylated amino compounds are those made by reacting an acylating agent having a hydrocarbyl substituent of at least 10 carbon atoms and a nitrogen compound characterized by the presence of at least one —NH— group. Typically, the acylating agent will be a mono- or polycarboxylic acid (or reactive equivalent thereof) such as a substituted succinic or propionic acid and the amino compound will be a polyamine or mixture of polyamines, most typically, a mixture of ethylene polyamines. The amine also may be a hydroxyalkyl-substituted polyamine. The hydrocarbyl substituent in such acylating agents preferably averages at least about 30 or 50 and up to about 400 carbon atoms.

Illustrative of hydrocarbyl substituent groups containing at least 10 carbon atoms are n-decyl, n-dodecyl, tetrapropenyl, n-octadecyl, oleyl, chlorooctadecyl, triicontanyl, etc. Generally, the hydrocarbyl substituents are made from homo- or interpolymers (e.g. copolymers, terpolymers) of mono- and di-olefins having 2 to 10 carbon atoms, such as ethylene, propylene, 1-butene, isobutene, butadiene, isoprene, 1-hexene, 1-octene, etc. Typically, these olefins are 1-monoolefins.

This substituent can also be derived from the halogenated (e.g. chlorinated or brominated) analogs of such homo-or interpolymers. The substituent can, however, be made from other sources such as monomeric high molecular weight alkenes (e.g. 1-tetra-contene) and chlorinated analogs and hydrochlorinated analogs thereof, aliphatic petroleum fractions, particularly paraffin waxes and cracked and chlorinated analogs and hydrochlorinated analogs thereof, white oils, synthetic alkenes such as those produced by the Ziegler-Natta process (e.g. poly(ethylene) greases) and other sources known to those skilled in the art. Any unsaturation in the substituent may be reduced or eliminated by hydrogenation according to procedures known in the art.

The hydrocarbyl substituents are predominantly saturated. The hydrocarbyl substituents are also predominantly aliphatic in nature, that is, they contain no more than one non-aliphatic moiety (cycloalkyl, cycloalkenyl or aromatic) group of 6 or less carbon atoms for every 10 carbon atoms in the substituent. Usually, however, the substituents contain no more than one such non-aliphatic group for every 50 carbon atoms, and in many cases, they contain no such non-aliphatic groups at all; that is, the typically substituents are purely aliphatic. Typically, these purely aliphatic substituents are alkyl or alkenyl groups.

Specific examples of the predominantly saturated hydrocarbyl substituents containing an average of more than 30 carbon atoms are the following: a mixture of poly(ethylene/propylene) groups of about 35 to about 70 carbon atoms; a mixture of poly(propylene/1-hexene) groups of about 80 to about 150 carbon atoms; a mixture of poly(isobutene) groups having an average of 50 to 75 carbon atoms; a mixture of poly (1-butene) groups having an average of 50-75 carbon atoms.

A preferred source of the substituents are poly(isobutene)s obtained by polymerization of a C4 refinery stream having a butene content of 35 to 75 weight percent and isobutene content of 30 to 60 weight percent in the presence of a Lewis acid catalyst such as aluminium trichloride or boron trifluoride. These polybutenes predominantly contain monomer repeating units of the configuration

—C(CH₃)₂CH₂—

The hydrocarbyl substituent is attached to the succinic acid moiety or derivative thereof via conventional means, for example the reaction between maleic anhydride and an unsaturated substituent precursor such as a polyalkene, as described for example in EP-B-0 451 380.

One procedure for preparing the substituted succinic acylating agents involves first chlorinating the polyalkene until there is an average of at least about one chloro group for each molecule of polyalkene. Chlorination involves merely contacting the polyalkene with chlorine gas until the desired amount of chlorine is incorporated into the chlorinated polyalkene. Chlorination is generally carried out at a temperature of about 75° C. to about 125° C. If desired, a diluent can be used in the chlorination procedure. Suitable diluents for this purpose include poly- and perchlorinated and/or fluorinated alkanes and benzenes.

The second step in the procedure is to react the chlorinated polyalkene with the maleic reactant at a temperature usually within the range of about 100° C. to about 200° C. The mole ratio of chlorinated polyalkene to maleic reactant is usually about 1:1. However, a stoichiometric excess of maleic reactant can be used, for example, a mole ratio of 1:2. If an average of more than about one chloro group per molecule of polyalkene is introduced during the chlorination step, then more than one mole of maleic reactant can react per molecule of chlorinated polyalkene. It is normally desirable to provide an excess of maleic reactant; for example, an excess of about 5% to about 50%, for example 25% by weight. Unreacted excess maleic reactant may be stripped from the reaction product, usually under vacuum.

Another procedure for preparing substituted succinic acid acylating agents utilises a process described in U.S. Pat. No. 3,912,764 and U.K. Pat. No. 1,440,219.

According to that process, the polyalkene and the maleic reactant are first reacted by heating them together in a direct alkylation procedure. When the direct alkylation step is completed, chlorine is introduced into the reaction mixture to promote reaction of the remaining unreacted maleic reactants. According to the patents, 0.3 to 2 or more moles of maleic anhydride are used in the reaction for each mole of polyalkene. The direct alkylation step is conducted at temperatures to 180° C. to 250° C. During the chlorine-introducing stage, a temperature of 160° C. to 225° C. is employed.

Other known processes for preparing the substituted succinic acylating agents include the one-step process described in U.S. Pat. Nos. 3,215,707 and 3,231,587. Basically, this process involves preparing a mixture of the polyalkene and the maleic reactant in suitable proportions and introducing chlorine into the mixture, usually by passing chlorine gas through the mixture with agitation, while maintaining a temperature of at least about 140° C.

Usually, where the polyalkene is sufficiently fluid at 140° C. and above, there is no need to utilise an additional substantially inert, normally liquid solvent/diluent in the one-step process. However, if a solvent/diluent is employed, it is preferably one that resists chlorination such as the poly- and per-chlorinated and/or -fluorinated alkanes, cycloalkanes, and benzenes.

Chlorine may be introduced continuously or intermittently during the one-step process. The rate of introduction of the chlorine is not critical although, for maximum utilisation of the chlorine, the rate should be about the same as the rate of consumption of chlorine in the course of the reaction. When the introduction rate of chlorine exceeds the rate of consumption, chlorine is evolved from the reaction mixture. It is often advantageous to use a closed system, including superatmospheric pressure, in order to prevent loss of chlorine so as to maximize chlorine utilisation.

The minimum temperature at which the reaction in the one-step process takes place at a reasonable rate is about 140° C. Thus, the minimum temperature at which the process is normally carried out is in the neighbourhood of 140° C. The preferred temperature range is usually between about 160° C. and about 220° C. Higher temperatures such as 250° C. or even higher may be used but usually with little advantage. In fact, excessively high temperatures may be disadvantageous because of the possibility that thermal degradation of either or both of the reactants may occur at excessively high temperatures.

In the one-step process, the molar ratio of maleic reactant to chlorine is such that there is at least about one mole of chlorine for each mole of maleic reactant to be incorporated into the product. Moreover, for practical reasons, a slight excess, usually in the neighbourhood of about 5% to about 30% by weight of chlorine, is utilised in order to offset any loss of chlorine from the reaction mixture. Larger amounts of excess chlorine may be used.

The attachment of the hydrocarbyl substituent to the succinic moiety may alternatively be achieved via the thermally-driven ‘ene’ reaction, in the absence of chlorine. Use of such a material is the acylating agent (i) leads to products having particular advantages; for example, chlorine-free products having excellent detergency and lubricity properties. In such products, the reactant (i) is preferably formed from a polyalkene having at least 30% preferably 50% or more such as 75% of residual unsaturation in the form of terminal, e.g. vinylidene, double bonds.

The polyamines suitable in this invention are those comprising amino nitrogens linked by alkylene bridges, which amino nitrogens may be primary, secondary and/or tertiary in nature. The polyamines may be straight chain, wherein all the amino groups will be primary or secondary groups, or may contain cyclic or branched regions or both, in which case tertiary amino groups may also be present. The alkylene groups are preferably ethylene or propylene groups, with ethylene being preferred. Such materials may be prepared from the polymerisation of lower alkylene diamines such as ethylene diamine, a mixture of polyamines being obtained, or via the reaction of dichloroethane and ammonia.

The present invention has discovered that the nature of the polyamine, and in particular the relative proportions of different polyamines within a polyamine mixture, may have an important bearing on the performance of the product defined under the invention.

(1) Polyalkylene Polyamines of the General Formula IV

(R⁶)₂N[U—N(R⁶)]_{qN}(R⁶)₂ IV

wherein each R⁶ independently represents a hydrogen atom, a hydrocarbyl group or a hydroxy-substituted hydrocarbyl group containing up to about 30 carbon atoms, with the proviso that at least one R⁶ represents a hydrogen atom, q represents an integer in the range from 1 to 10 and U represents a C₁₋₁₈ alkylene group;

(2) Heterocyclic-Substituted Polyamines Including Hydroxyalkyl-Substituted Polyamines

wherein the polyamines are described above and the heterocyclic substituent is for example a piperazine, an imidazoline, a pyrimidine, or a morpholine; and

(3) Aromatic Polyamines of the General Formula V

Ar(NR⁶₂)_{y} V

wherein Ar represents an aromatic nucleus of 6 to about 20 carbon atoms, each R⁶ is as defined hereinabove and y represents a number from 2 to about 8.

Specific examples of the polyalkylene polyamines (1) are ethylene diamine, tetra(ethylene)pentamine, tri-(trimethylene)tetramine, and 1,2-propylene diamine. Specific examples of hydroxyalkyl-substituted polyamines include N-(2-hydroxyethyl) ethylene diamine, N,N¹-bis-(2-hydroxyethyl) ethylene diamine, N-(3-hydroxybutyl) tetramethylene diamine, etc. Specific examples of the heterocyclic-substituted polyamines (2) are N-2-aminoethyl piperazine, N-2 and N-3 amino propyl morpholine, N-3-(dimethyl amino) propyl piperazine, 2-heptyl-3-(2-aminopropyl) imidazoline, 1,4-bis (2-aminoethyl) piperazine, 1-(2-hydroxy ethyl) piperazine, and 2-heptadecyl-1-(2-hydroxyethyl)-imidazoline, etc. Specific examples of the aromatic polyamines (3) are the various isomeric phenylene diamines, the various isomeric naphthalene diamines, etc.

Many patents have described useful acylated nitrogen compounds including U.S. Pat. Nos. 3,172,892; 3,219,666; 3,272,746; 3,310,492; 3,341,542; 3,444,170; 3,455,831; 3,455,832; 3,576,743; 3,630,904; 3,632,511; 3,804,763 and 4,234,435, and including European patent applications EP 0 336 664 and EP 0 263,703. A typical and preferred compound of this class is that made by reacting a poly(isobutylene)-substituted succinic anhydride acylating agent (e.g. anhydride, acid, ester, etc.) wherein the poly(isobutene) substituent has between about 50 to about 400 carbon atoms with a mixture of ethylene polyamines having 3 to about 7 amino nitrogen atoms per ethylene polyamine and about 1 to about 6 ethylene groups. In view of the extensive disclosure of this type of acylated amino compound, further discussion of their nature and method of preparation is not needed here. The above-noted US patents are utilized for their disclosure of acylated amino compounds and their method of preparation.

Preferred materials also include those made from amine mixtures comprising polyamines having seven and eight, and optionally nine, nitrogen atoms per molecule (so-called ‘heavy’ polyamines).

More preferably, the polyamine mixture comprises at least 45% and preferably 50% by weight of polyamines having seven nitrogen atoms per molecule, based on the total weight of polyamines.

The polyamine component (ii) may be defined by the average number of nitrogen atoms per molecule of the component (ii), which may preferably be in the range of 6.5 to 8.5, more preferably 6.8 to 8, especially 6.8 to 7.5 nitrogens per molecule. The number of nitrogens appears to influence the ability of the product to provide deposit control.

The reaction of polyamine with the acylating agent is carried out in the appropriate ratio, as above defined. Preferably, the molar ratio of acylating agent to polyamine is in the range of from 2.5:1, to 1.05:1 preferably 1.7:1 or 1.05:1, such as 1.35:1 to 1.05:1, more preferably 1.3:1 to 1.15:1, and most preferably 1.25:1 to 1.15:1. For this purpose, the molar quantity of acylating agent refers to the molar quantity of polyisobutylene succinic anhydride (pibsa) formed during the reaction procedure as previously described, and does not typically refer to the total molar quantity of polyisobutylene (pib) found in the pibsa reactant (i) which may be higher if unreacted pib remains from the pibsa formation reaction. The molar quantity of pibsa is typically determined by titration, e.g. via saponification of the reacted maleic anhydride moieties. The specific mixture of individual reaction products obtained by operating within such ratios has been found to be particularly useful for fuel oil applications, especially middle distillate fuel oil applications.

The reaction is typically carried out at conventional temperatures in the range of about 80° C. to about 200° C., more preferably about 140° C. to about 180° C. These reactions may be conducted in the presence or absence of an ancillary diluent or liquid reaction medium, such as a mineral oil or aromatic solvent. If the reaction is conducted in the absence of an ancillary solvent of this type, such is usually added to the reaction product on completion of the reaction. In this way the final product is in the form of a convenient solution and thus is compatible with an oil. The same solvent could be used in the manufacturing of the metal detergent. Suitable solvent oils are oils used as a lubricating oil basestock, and these generally include lubricating oils having a viscosity (ASTM D 445) of 2 to 40, preferably 3 to 12 mm²/sec at 100° C., with the primarily paraffinic mineral oils, such as those in the range of Solvent 90 to Solvent 150 Neutral, being preferred.

More preferred are aromatic solvents which give rise to particularly low viscosity products and result in products having surprisingly advantageous compatibility when blended with other components in the additive. Advantageous solvents include xylenes, trimethylbenzene, ethyl toluene, diethylbenzene, cymenes, amylbenzene, diisopropyl benzene, or mixtures thereof, optionally with isoparaffins. Products obtained via reaction in such solvents can be blended to form particularly homogeneous additives containing other additive components.

Another type of acylated nitrogen compound belonging to this class is that made by reacting the afore-described alkylene amines with the afore-described substituted succinic acids or anhydrides and aliphatic mono-carboxylic acids having from 2 to about 22 carbon atoms. In these types of acylated nitrogen compounds, the mole ratio of succinic acid to mono-carboxylic acid ranges from about 1:0.1 to about 0.1:1, such as 1:1. Typical of the mono-carboxylic acid are formic acid, acetic acid, dodecanoic acid, butanoic acid, oleic acid, stearic acid, the commercial mixture of stearic acid isomers known as isosteric acid, tolyl acid, etc. Such materials are more fully described in U.S. Pat. Nos. 3,216,936 and 3,250,715.

Still another type of acylated nitrogen compound useful as compatibilising agent is the product of the reaction of a fatty monocarboxylic acid of about 12-30 carbon atoms and the afore-described alkylene amines, typically, ethylene, propylene or trimethylene polyamines containing 2 to 8 amino groups and mixtures thereof. The fatty mono-carboxylic acids are generally mixtures of straight and branched chain fatty carboxylic acids containing 12-30 carbon atoms. A widely used type of acylating nitrogen compound is made by reacting the afore-described alkylene polyamines with a mixture of fatty acids having from 5 to about 30 mole percent straight chain acid and about 70 to about 95 mole percent branched chain fatty acids. Among the commercially available mixtures are those known widely in the trade as isostearic acid. These mixtures are produced as by-product from the dimerization of unsaturated fatty acids as described in U.S. Pat. Nos. 2,812,342 and 3,260,671.

The branched chain fatty acids can also include those in which the branch is not alkyl in nature, such as found in phenyl and cyclohexyl stearic acid and the chlorostearic acids. Branched chain fatty carboxylic acid/alkylene polyamine products have been described extensively in the art. See for example, U.S. Pat. Nos. 3,110,673; 3,251,853; 3,326,801; 3,337,459; 3,405,064; 3,429,674; 3,468,639; 3,857,791. These patents are utilized for their disclosure of fatty acid-polyamine condensates for their use in oleaginous formulations.

The preferred acylated nitrogen compounds are those made by reacting a poly (isobutene) substituted succinic anhydride acylating agent with mixtures of ethylene polyamines as hereinbefore described.

Additive Composition

An additive composition or concentrate comprising the detergents of the present invention may be in admixture with a carrier liquid (e.g. as a solution or a dispersion). Such concentrates are convenient as a means for incorporating the metal compounds into bulk fuel oil such as distillate fuel oil, which incorporation may be done by methods known in the art. The concentrates may also contain other fuel additives as required and preferably contain from 1 to 75 mass %, more preferably 2 to 60 mass %, most preferably 5 to 50 mass % of the additives, based on active ingredient, preferably in solution in the carrier liquid. Examples of carrier liquids are organic solvents including hydrocarbon solvents, for example petroleum fractions such as naphtha, kerosene, lubricating oil, diesel fuel oil and heating oil; aromatic hydrocarbons such as aromatic fractions, e.g. those sold under the ‘SOLVESSO’ tradename; alcohols such as hexanol and higher alkanols; esters such as rapeseed methyl ester and paraffinic hydrocarbons such as hexane and pentane and isoparaffins. The carrier liquid must, of course, be selected having regard to its compatibility with the additives and with the fuel oil.

The detergents of the present invention may be incorporated into the bulk fuel oil by other methods such as those known in the art. If co-additives are required, they may be incorporated into the bulk fuel oil at the same time as the metal compounds of the present invention or at a different time.

Accordingly, the present invention also provides a process for preparing a fuel oil composition either wherein an additive comprising the detergents is incorporated, preferably by blending or mixing, into a fuel oil, or wherein the detergents of the present invention are incorporated, preferably by blending or mixing, into the fuel oil contemporaneously or sequentially.

Co-Additives

The detergents of the present invention may be used in combination with one or more co-additives such as known in the art, for example the following: cold flow improvers, wax anti-settling agents, dispersants, antioxidants, corrosion inhibitors, dehazers, demulsifiers, metal deactivators, antifoaming agents, cetane improvers, cosolvents, package compatibilisers, other lubricity additives, biocides and antistatic additives.

It should be appreciated that interaction may take place between any two or more of the compounds of the present invention after they have been incorporated into the fuel oil or additive composition, for example, between two different neutral alkaline earth metal compounds or between a neutral alkaline earth metal compound and a neutral alkali metal or between a neutral alkaline earth metal compound and a transition metal compound or between a neutral alkaline earth metal compound, a neutral alkali metal compound and a transition metal compound. The interaction may take place in either the process of mixing or any subsequent condition to which the composition is exposed, including the use of the composition in its working environment. Interactions may also take place when further auxiliary additives are added to the compositions of the invention or with components of fuel oil. Such interaction may include interaction which alters the chemical constitution of the metal compounds. Thus for example the compositions of the invention include compositions in which interaction between any of the metal compounds has occurred, as well as compositions in which no interaction has occurred between the components mixed in the fuel oil.

The Engines

The engines primarily suited to the process of the invention are those four stroke marine diesel engines defined by the above operating parameters and found primarily in fishing vessels and other medium-sized craft. This combination of parameters appear to correlate both with the type of application for these engines, and also with the problems observed during use. Alternatively, two-stroke engines having the above operating parameters may be used. Such engines may also be found in stationary applications and railway applications.

The four stroke engines suitable in the invention preferably possess the operating parameters (i) and (ii) as defined above, more preferably the parameters (i), (ii) and (iii), and most preferably the parameters (i), (ii), (iii) and (iv).

The two stroke engines suitable in the invention preferably possess the operating parameters (i) and (ii) as defined above, more preferably the parameters (i), (ii) and (iii) and most preferably the parameters (i), (ii), (iii) and (iv).

Of the four-stroke engines, particularly suitable engines are those having a power output of above 250 bhp, and especially those having an output over 600 bhp, such as over 1000 bhp. Especially suitable are those having cylinder bore dimensions of greater than 180 mm and piston strokes of greater than 180 mm and more preferably bores of greater than 240 mm and strokes of greater than 290 mm, such as bores of greater than 320 and strokes of greater than 320 mm, including the largest engines having bores of greater than 430 mm and strokes of greater than 600 mm.

Of the two-stroke engines, particularly suitable engines are those having a power output above 200 bhp and more preferably above 1000 bhp. Especially suitable are those engines having bores of greater than 240 mm, such as greater than 400 or 500 mm, and strokes of greater than 400 mm or 500 mm, such as greater than 1000 mm. Such large two-stroke engines include the “crosshead” type engines used in marine applications.

The invention will now be illustrated with the following examples:

### EXAMPLE 1

Lubricating oil viscosity tests were performed using two 15W40 multigrade oils. Oil 1 was a standard CEC crankcase oil used for CEC fuel tests and passing the Renault 5, Mercedes 102E and M-111, Peugeot XUD9 and VW Waterboxer test requirements. Oil 2 satisfied the API CE and CF4 requirements.

Additives A and B were tested in each oil at the 1% and 10% levels and the kinematic viscosities (at 40° C.) of the resulting compositions measured.

Additive A was a neutral calcium sulfonate wherein the sulfonate was substituted with a mixture of alkyl chains containing 36 carbons and 12 carbons. Additive B was a polyisobutylene succinimide having a polyisobutylene chain of Mn approximately 950.

TABLE 1
Viscosity Results

Lubricity Oil Viscosity
(KV @ 40° C.)

| | Oil 1 | Oil 2 |
|---|---|---|
| Oil | 101.3 | 98.62 |
| Oil + Additive A (1%) | 105.9 | 100.2 |
| Oil + Additive A (10%) | 118.5 | 112.6 |
| Oil + Additive B (1%) | 107.6 | 101.8 |
| Oil + Additive B (10%) | 121.6 | 117.9 |

### EXAMPLE 2

### Engine Testing

Additives A and B, along with further additive C, were tested in a KH Deutz marine engine and the resulting engine deposits and wear on the pistons, piston rings and cylinder lines measured.

The engine had the following characteristics:

| | |
|---|---|
| Type: | Single cylinder |
| Bore: | 240 mm |
| Stroke: | 280 mm |
| Speed: | 900 rpm |
| Power: | 225 kW |

The effects of the combination of additives A and B, were compared to the effects observed in the absence of additives, for each of two reference lubricating oils (high and medium quality). Each test run involved 192 hours of engine operation after which the engine parameters shown in the table were measured. In addition the combination of A and C was run on high quality oil, but only for a period of 160 hours due to mechanical failure of the test bed.

TABLE 2
Engine Test Results

| | | | | | | Medium Quality | |
|---|---|---|---|---|---|---|---|
| | High Quality Lubricating Oil | | | | | Lubricating Oil | |
| Parameter | A + B¹ | A + C² | Ref 1 | Ref 2 | Ref 3 | A + B | Ref |
| Piston Land & grooves, | 60 | 33 | 115 | 134 | 197 | 177 | 161 |
| Total weighed demerits³ | | | | | | | |
| Cylinder lacquers, merits⁴ | | | | | | | |
| Full ring travel | 9.45 | 9.35 | 9.35 | 8.93 | 8.78 | 8.25 | 8.06 |
| Top 25% | 8.76 | 8.39 | 8.46 | 7.50 | 7.67 | 6.44 | 6.05 |
| Bore polish, %⁵ | 0 | — | 0 | 0 | 0 | 0 | 0 |
| Top Land (Crown Land) | 46 | 1 | 42 | 35 | 41 | 31 | 47 |
| Polished Carbon, % | | | | | | | |
| Top Groove Fill, % | 0 | 0 | 0 | 0 | 1 | 2 | 2 |
| 2^{nd} Groove Fill, % | 0 | 2 | 2 | 2 | 4 | 8 | 26 |

Footnotes to table:
¹Additive combination ‘A + B’ comprised 46.6% by weight of A, 25.0% by weight of B, 25.4% by weight of aromatic solvent and 3.0% by weight of a polyoxyalkylene based demulsifier (not believed to affect the engine parameters measured), to a total treat rate of 500 ppm (weight of additive to weight of fuel).
²Additive combination A + C comprised a corresponding formulation, but wherein additive C was a calcium phenate having TBN (total base number) of 147 and containing 70% of the calcium in the form of an inorganic salt combination with phenate anion, the remainder being inorganic calcium associated with the modicum of overbasing present.
³Demerits refers to the degree of deposition, i.e. the greater the demerits the poorer (dirtier) the condition of the piston
⁴conversely, merits refers to the degree of cleanliness of the cylinder on a scale of 0 (dirty) to 10 (clean). Thus, greater merits indicates less laquer and a cleaner surface
⁵bore polish not recorded for ‘A + C’.

The advantageous results of the present invention are clearly seen from Table 2. Combinations A+B and A+C showed substantially lower piston demerits (i.e. lower piston deposits). A+B was particularly effective also against cylinder laquer, whilst A+C showed particularly good control of polish on the piston top land.

1. A process for operating a diesel engine comprising:
a) the preparation of a diesel fuel or fuel oil composition by admixture of a diesel fuel or fuel oil and one or more additives comprising a metal containing detergent, non-metal containing detergent or both;
b) supplying the fuel composition to an engine having one or more of the following operating parameters:
(i) a maximum engine speed of no more than 1000 rpm (revolutions per minute) for four stroke engines, and of no more than 2,500 ppm for two stroke engines;
(ii) a power output of greater than 200 bhp (brake horse-power);
(iii) a cylinder bore dimension of greater than 150 mm for four stoke engines, or of greater than 100 mm for two stroke engines; and
(iv) a piston stroke of greater than 150 mm for four stoke engines, or of greater than 120 mm for two-stroke engines.

2. The process of claim 1 wherein the fuel is a marine diesel fuel.

3. The process of any preceding claim wherein the engine is a four stroke or two stroke engine having the parameters (i) and (ii).

4. The process of any preceding claim wherein the engine is a four stroke engine have the parameters (i), (ii), (iii) and (iv).

5. The process of claim 1 or claim 2 wherein the engine is a two stroke engine having the parameters (i), (ii), (iii) and (iv).

6. The process of any preceding claim wherein the fuel composition is prepared by admixture of the fuel with both a metal-containing detergent and a non-metal containing detergent.

7. The process of any preceding claim wherein the metal containing detergent is a neutral calcium sulfonate or salicylate.

8. The process of any of claims 1 to 6 wherein the metal containing detergent is a calcium phenate.

9. The process of any preceding claim wherein the non-metal containing detergent is a hydrocarbyl succinimide formed from the reaction of a hydrocarbyl succinic anhydride or reactive equivalent thereof and a polyalkylene polyamine.

10. The use of the diesel fuel or fuel oil composition defined in any one of the preceding claims, in a diesel engine having the operating parameters defined in any one of the preceding claims, to improve the oil consumption of the engine or reduce the in-cylinder deposits of the engine, or both.
